(19) United States
(12) Patent Application Publication
(10) Pub. No.: US 2009/0304846 A1
(43) Pub. Date: Dec. 10, 2009

(54) APPARATUS FOR MOVING A WORKING MEDIUM

(75) Inventor: Guido Knobel, Warth (CH)

Correspondence Address: DYKEMA GOSSETT PLLC, 39577 WOODWARD AVENUE, SUITE 300, BLOOMFIELD HILLS, MI, 48304-5086, US

(73) Assignee: KMB PRODUKTIONS AG, Felben (CH)

(21) Appl. No.: 12/162,949

(22) PCT Filed: Jan. 31, 2007
(86) PCT No.: PCT/EP07/00798

§ 371 Date: Nov. 19, 2008

(30) Foreign Application Priority Data
Jan. 31, 2006 (DE) 10 2006 004 655.2

(51) Int. Cl. A23G 1/20; A23G 3/02

(52) U.S. Cl. 425/446

(57) ABSTRACT

An apparatus for moving a working medium in connection with the production and/or modification of confectionary products. In an embodiment, the apparatus includes a housing, a working element, and a linear drive that is configured to move the working element in at least one direction (X, Y, Z).

The invention relates to an apparatus for moving a working medium in the food or chemical industry, in particular for use in the production and/or modification of confectionery products, for example in a chocolate molding or decorating machine.

### PRIOR ART

In many sectors of the food or chemical industry it is necessary to move a given working medium in space, it being desirable for the working medium to be able to approach any given position in space. By way of example only, reference is made to DE 198 11 403 A1, which discloses an apparatus for producing confectionery goods. In the cited document, spreader units for a pourable mass are moved along an X, Y, and Z direction by pneumatic or hydraulic means or by use of electric motors.

Another working medium is disclosed in DE 297 06 282 U, wherein a number of pumps are provided in a pump support by means of which a filling for chocolates may be delivered from a feed hopper into an appropriate mold by means of a nozzle.

### OBJECT OF THE INVENTION

The object of the present invention is to provide an apparatus of the above-referenced type in which the movement of the working medium is significantly improved.

### ACHIEVEMENT OF THE OBJECT

The object is achieved by the fact that the working medium is moved in at least one direction by means of a linear drive.

This linear drive is preferably a specialized drive which has not been used heretofore in the food or chemical industry. The linear drive operates inductively by means of a magnetic field which acts on a magnetic plate on the working medium to be moved or rotated, and moves the magnetic plate, and therefore the working medium. By controlling the magnetic field it is possible to make a very precise and repeatable approach to a desired position. Because the drive operates in a contactless manner, there is no abrasion or need for lubricant or the like, thus preventing soiling of the surroundings. This has proven to be very advantageous, in particular when such a linear drive is used in the production of confectionery products.

Three linear drives are preferably provided, thus allowing the working medium to be moved in the X, Y, and Z directions so that any given position in space may be assumed.

The working medium is preferably guided over runners in carriages, with either the carriages traveling along the runners, or the runners sliding in carriages by means of ball bearings.

### DESCRIPTION OF THE FIGURES

Further advantages, features, and particulars of the invention result from the following description of preferred exemplary embodiments and with reference to the drawings, which show the following:

FIG. 1 shows a perspective view of an apparatus according to the invention for moving a working medium;

FIG. 2 shows a front view of the apparatus according to the invention shown in FIG. 1;

FIG. 3 shows a cross section of the apparatus according to FIG. 2, along section line A-A; and

FIG. 4 shows a top view of the apparatus according to the invention shown in FIG. 1.

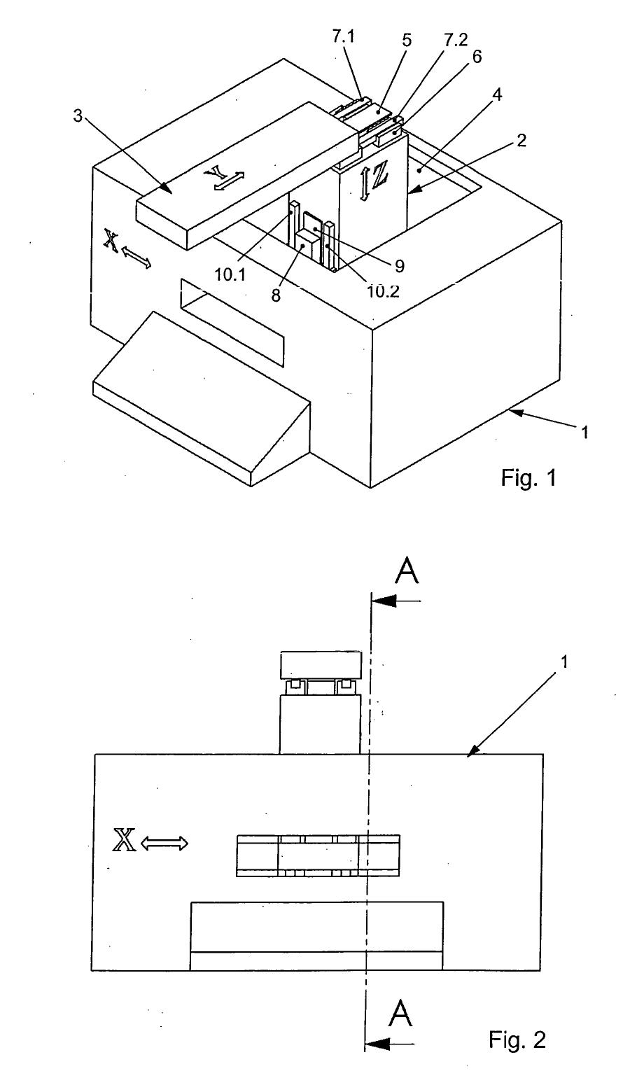

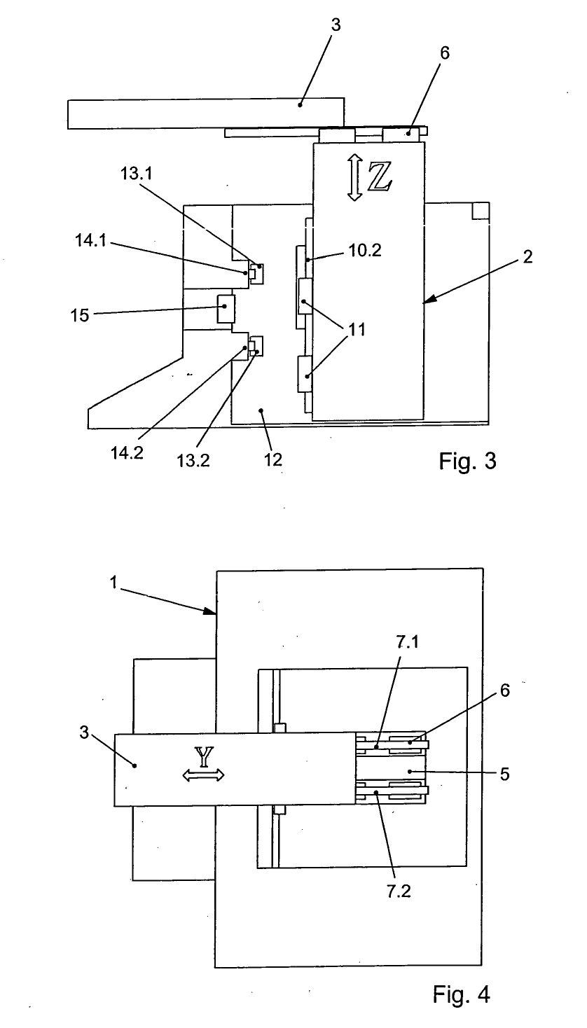

According to FIG. 1, an apparatus according to the invention for moving a working medium, such as a pump support 3, for example, which is displaceable in the Y direction has a housing 1. By means of a linear drive 5 the pump support 3 may be displaced with respect to a lifting column 2 in direction Y. This linear drive 5 inductively generates a magnetic field and cooperates with a magnetic plate present on the underside of the pump support 3, thus allowing the pump support 3 to be moved back and forth in the direction of the double arrow Y. The pump support 3 is connected to runners 7.1 and 7.2, over which the pump support slides in carriages 6 by means of corresponding ball bearings.

An independent linear drive 8 in the housing 1 is associated with the lifting column 2; FIG. 1 also shows a magnetic plate 9 on the lifting column 2.

This magnetic plate 9 rests securely against the lifting column 2.

The lifting column 2 is guided in the direction of the double arrow Z by means of runners 10.1. and 10.2, which in turn slide in carriages 11.

The lifting column 2 rests on a sliding cradle 12, which in turn has carriages 13.1. and 13.2, except that in this case the carriages slide [in] runners 14.1 and 14.2. The sliding cradle 12 is moved in the direction of the double arrow X, once again by means of a linear drive 15 which has the design of linear drive 5 or linear drive 8.

The pump support 3 may be moved to any desired position in space by means of the three linear drives 5, 8, and 15.

List of reference numerals

| | |
|---|---|
| 1 | Housing |
| 2 | Lifting column |
| 3 | Pump support |
| 4 | Opening |
| 5 | Linear drive |
| 6 | Carriages |
| 7 | Runners |
| 8 | Linear drive |
| 9 | Magnetic plate |
| 10 | Runners |
| 11 | Carriages |
| 12 | Sliding cradle |
| 13 | Carriages |
| 14 | Runners |
| 15 | Linear drive |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |

1-4. (canceled)

5. An apparatus for moving a working medium in connection with the production and/or modification of confectionary products, the apparatus comprising:
a housing;
a working element; and
a linear drive that is configured to move the working element in at least one direction (X, Y, or Z).

6. The apparatus of claim 5, wherein the apparatus is a chocolate molding or decorating machine.

7. The apparatus of claim 5, wherein the working element is configured to move in a Y direction; apparatus includes a lifting column that is connected to the working element and is configured to move in a Z direction; and the lifting mechanism is connected to a sliding cradle that is configured to move in an X direction.

8. The apparatus of claim 5, wherein the apparatus is configured to move said working medium in an X, Y, and Z direction by one or more linear drives.

9. The apparatus according to claim 5, wherein the linear drive has at least one runner along which a carriage may be moved, or which may be moved along a carriage.

10. The apparatus according to claim 5, wherein the linear drive operates inductively by means of a magnetic field that acts on a magnetic plate.

11. The apparatus according to claim 5, wherein the working element includes a pump support.

12. An apparatus for moving a working medium in connection with the production and/or modification of confectionary products, the apparatus comprising:
a housing;
a lifting mechanism including a lifting magnetic plate and a sliding cradle; and
a working element including a working element magnetic plate positioned on the underside of the working element;
wherein a first linear drive is configured to generate a magnetic force or field that cooperates with the working element magnetic plate to move the working element in a first direction; and a second linear drive in the housing is configured to generate a magnetic force or field that cooperates with the lifting magnetic plate to move the lifting mechanism in a second direction; and a third linear drive is connected to the sliding cradle and is configured to move the sliding cradle in a third direction;
whereby the working element is configured to move to a desired position in space by operation of one of more of the first, second, and third linear drives.

13. The apparatus of claim 12, wherein the apparatus is a chocolate molding or decorating machine.

14. The apparatus of claim 12, wherein the working element is connected to runners over which the working element slides in carriages.

15. The apparatus of claim 12, wherein the lifting mechanism is guided by runners that slide in carriages.

16. The apparatus of claim 12, wherein the sliding cradle includes carriages that slide in runners.

17. A food product molding or decorating machine, the machine comprising:
a housing;
a lifting mechanism connected to the housing;
a working element connected to the lifting mechanism;
a means for moving the working element in a first direction;
a means for moving the lifting mechanism in a second direction; and
a means for moving the lifting mechanism in a third direction;
wherein the first direction, the second direction, and the third direction are normal to one another and correspond with X, Y, and Z directions in space, and whereby the working element is configured to move to a desired position in space.

18. The machine according to claim 17, wherein the means for moving the working element in a first direction, the means for moving the lifting mechanism in a second direction, and the means for moving the lifting mechanism in a third direction include linear drives.

19. The machine according to claim 18, wherein one or more of the linear drives generate a magnetic field to move an associated component moved by such one or more linear drives.

20. The machine according to claim 17, wherein the working element is a pump support.
